(19) United States
(12) Patent Application Publication
(10) Pub. No.: US 2006/0126768 A1
(43) Pub. Date: Jun. 15, 2006

(54) Offset QPSK filter for reducing adjacent channel interference

(76) Inventors: Nicolas Constantinidis, Cresscrons (FR); Guillaume Crinon, Douvres-la-Deelivrande (FR)

Correspondence Address: HOWISON & ARNOTT, L.L.P, P.O. BOX 741715, DALLAS, TX, 75374-1715, US

(21) Appl. No.: 11/011,660

(22) Filed: Dec. 14, 2004

(51) Int. Cl. H04B 1/10

(52) U.S. Cl. 375/350

(57) ABSTRACT

A method is disclosed for filtering a received RF signal modulated with a time series sampled data signal, each data sample occurring within a bit time. At least a portion of the signal is filtered such that in the frequency domain a portion of the high frequency energy therein is rejected to provide a filtered signal. In the time domain, substantial attenuation regions are disposed forward in time with the step of filtering such that the attenuation regions are disposed within the bit time of subsequent data samples of the time series sampled data signal in the time domain. Sampling of a given filtered received time series sampled data signal occurs substantially proximate in time to the substantial attenuation contributed by prior received data samples.

### TECHNICAL FIELD OF THE INVENTION

The present invention pertains in general to digital filters and, more particularly, to a digital filter that filters an incoming demodulated Offset-QPSK data stream in such a manner so as to reduce adjacent channel interference without introducing Inter-Symbol Interference (ISI).

### BACKGROUND OF THE INVENTION

Wireless transmission technologies have seen increased use due to the explosion of the wireless communication devices that allow computers to communicate with network interfaces, hands-free telephone handsets to communicate with a base station telephone, and other applications. In order to facilitate the transmission of data between one wireless transmitter and a wireless receiver, data is typically modulated onto a carrier with some type of modulation scheme and then the carrier transmitted to the receiver. The receiver then receives the carrier, demodulates the carrier and extracts the data therefrom as recovered data. Typical modulation schemes utilize a frequency shift key (FSK) modulation scheme or a phase shift key (PSK) modulation scheme. To obtain greater bandwidth efficiency, M-ary modulation schemes are the modulation scheme of choice. One such type of M-ary PSK utilizes quadrature modulation wherein in-phase and quadrature components of the signal are generated and, when the channels are independent of each other, this is known as quadrature PSK (QPSK). An even further variation of this, which is utilized for band-limited, non-linear channels, is offset quadrature phase shift keying (O-QPSK) and minimum shift keying (MSK). In a non-linear channel, the spectral side lobe of a filtered QPSK signal tends to be restored to its initial characteristics prior to filtering, whereas with O-QPSK and MSK, the signal envelope is constant, which makes these modulation techniques impervious to channel non-linear areas. The choice of O-QPSK (sometimes referred to as staggered QPSK), the I- and Q-bit streams are offset in time by one bit period, T_{c}. These are well known techniques and the O-QPSK modulation scheme is usually found in applications that are associated with band-limited, non-linear channels wherein band-limiting is necessary to meet spectrum occupancy allocations.

The power spectral density (PSD) of an O-QPSK modulated signal results in a number of lobes that, when processed through a modulator, and utilizing some type of matched filter, will result in recovery of all of the spectral information therefrom. However, in normal environments, there can be interference from adjacent channels that occurs within the energy spectrum of the O-QPSK recovered signal. For example, in a typical O-QPSK system, the main lobe in the energy spectrum has a width of +/−1.5 MHz. Thus, to reconstruct the signal and recover all the energy, the matched filter must recover the energy through the entire width of the main lobe and also the width of the smaller lobes that extend out from the +/−1.5 MHz by increments of 1.0 MHz. However, one interference source is what is referred to as “Blue Tooth” systems that will have a potential channel that is separated by 1.0 MHz from the center frequency of the O-QPSK signal. Therefore, there will be a potential source of interference that is disposed at a center frequency of 1.0 MHz from the center of the current channel with a band-width of +/−0.5 MHz. Therefore, at a distance of 0.5 MHz from the center frequency of the given channel, there is a potential for interference from the adjacent channel. Thus, it would be desirable to provide a band-pass filter that will filter out the adjacent channel. Although approximately 80% of the power spectral density will be recovered if the band pass filter cuts off sharply at +/−0.5 MHz, such filtering can result in a high degree of Inter-Symbol Interference (ISI). Thus, one has to make trade-offs between capturing the entire energy in the energy spectrum associated with the captured signal and thus being required to tolerate the adjacent channel interference, or filtering out the adjacent channel interference and then tolerating the ISI associated with that filtering function.

### SUMMARY OF THE INVENTION

The present invention disclosed and claimed herein, in one aspect thereof, comprises a method for filtering a received RF signal modulated with a time series sampled data signal, each data sample occurring within a bit time. At least a portion of the signal is filtered such that in the frequency domain a portion of the high frequency energy therein is rejected to provide a filtered signal. In the time domain, substantial attenuation regions are disposed forward in time with the step of filtering such that the attenuation regions are disposed within the bit time of subsequent data samples of the time series sampled data signal in the time domain. Sampling of a given filtered received time series sampled data signal occcurs substantially proximate in time to the substantial attenuation contributed by prior received data samples. BRIEF DESCRIPTION OF THE DRAWINGS

For a more complete understanding of the present invention and the advantages thereof, reference is now made to the following description taken in conjunction with the accompanying Drawings in which:

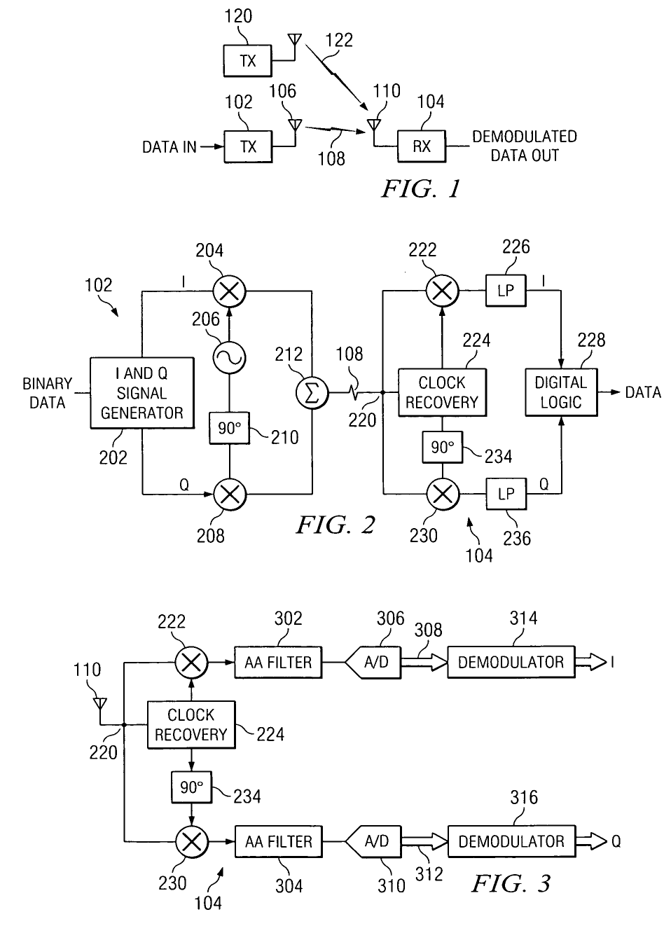

FIG. 1 illustrates an overall diagrammatic view of a transmission system with an interfering signal;

FIG. 2 illustrates a diagrammatic view of a transmitter and receiver operating in accordance with the disclosed system;

FIG. 3 illustrates a more detailed diagrammatic view of the receiver;

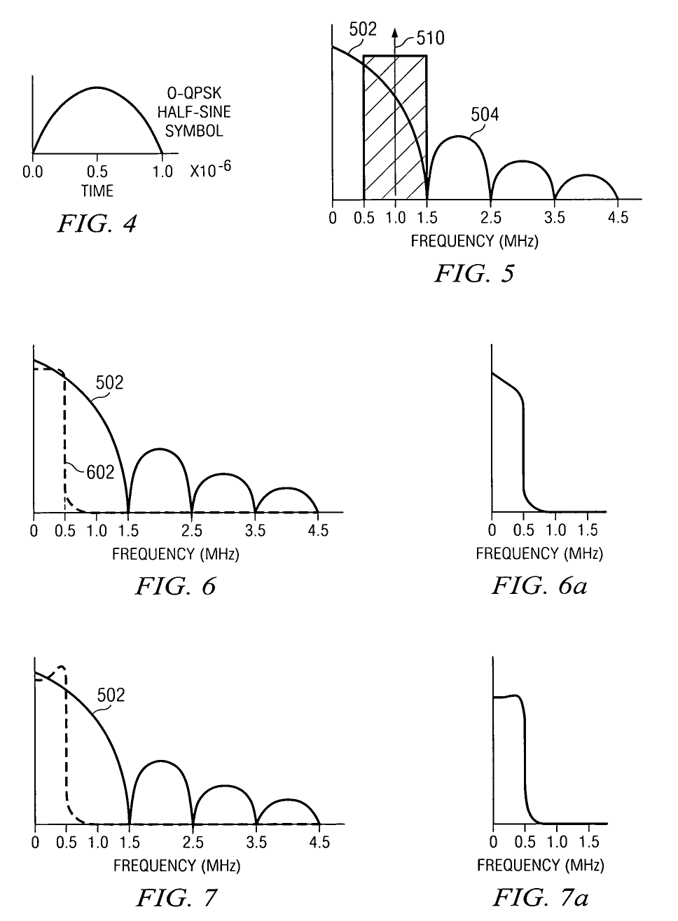

FIG. 4 illustrates a diagram of the time domain of a half-sine symbol;

FIG. 5 illustrates a frequency plot of the power spectral density of the O-QPSK signal;

FIG. 6 illustrates a plot of the power spectral density for an O-QPSK signal with a raised cosine filter;

FIG. 6a illustrates the channel response for the filtered O-QPSK signal;

FIG. 7 illustrates the power spectral density for the unfiltered O-QPSK signal as a solid line and the power spectral density for the baseband filter response of one embodiment as a dotted line;

FIG. 7a illustrates the power spectral density for the channel response after filtering;

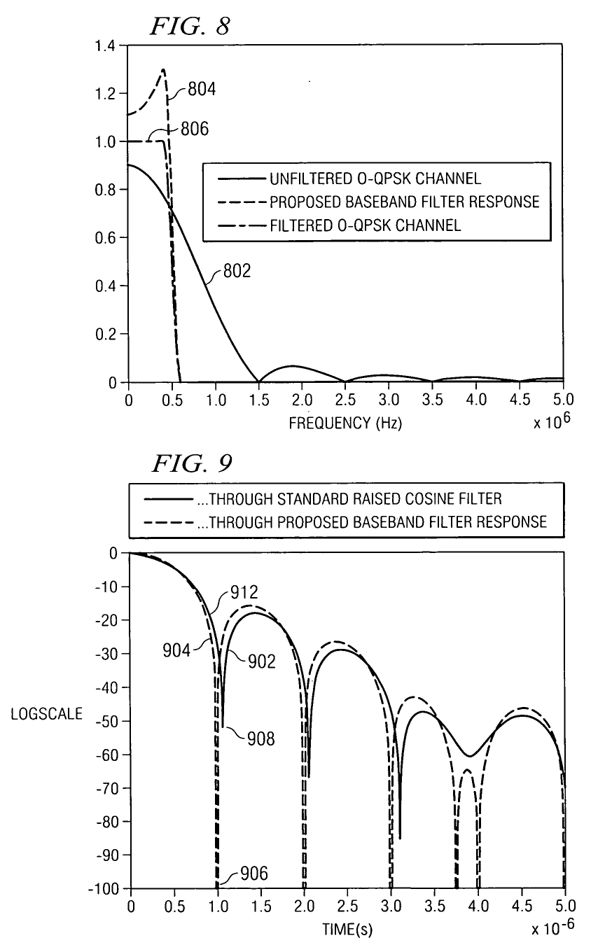

FIG. 8 illustrates a plot of one example of the O-QPSK filter;

FIG. 9 illustrates the channel time response for the raised cosine filter of FIG. 6a and the filter response of FIG. 7a;

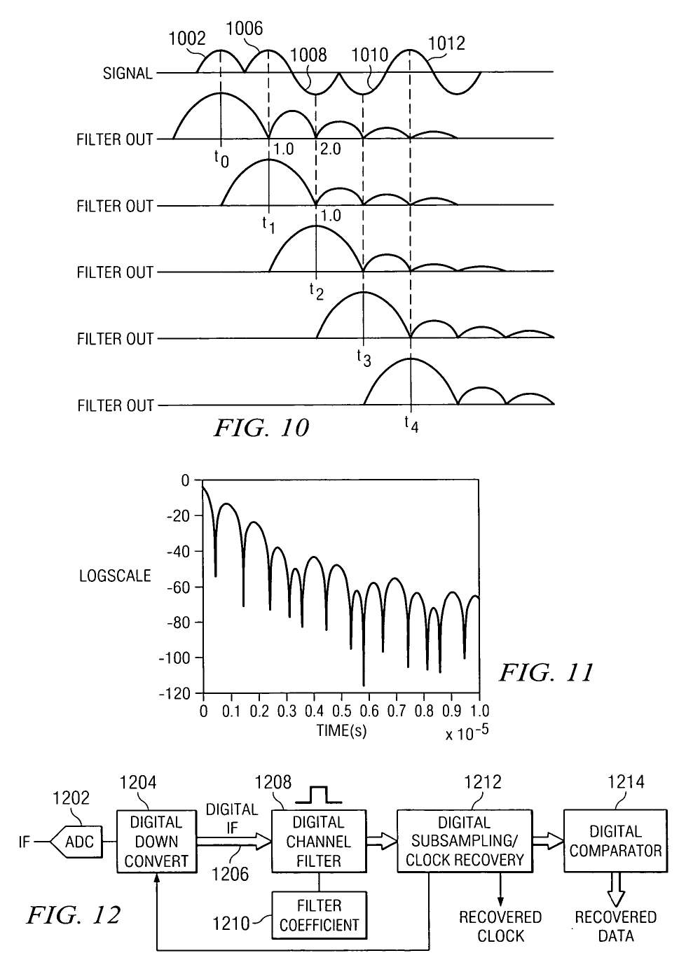

FIG. 10 illustrates the time response for multiple half-sine signals in a received signal stream;

FIG. 11 illustrates a FIR filter implementation of the baseband filter of the disclosed embodiment; and

FIG. 12 illustrates a diagrammatic view of the IF portion of the receiver.

### DETAILED DESCRIPTION OF THE INVENTION

Referring now to the drawings, and more particularly to FIG. 1, there is illustrated a diagrammatic view of a communications system. The primary communications system is comprised of a transmitter 102 and the receiver 104. The transmitter 102 has a transmitting antennae 106 associated therewith for transmitting over an RF link 108 to a receiving antennae 110 on the receiver 104. The transmitter 102 is operable to receive input data, modulate that input data onto a carrier and transmit that carrier over the communication link 108 to the receiver 104. The receiver 104 is operable to receive the carrier, demodulate the carrier and then recover data therefrom and output this recovered data. However, the quality of the data recovery operation in the form of demodulation, etc., is a function of the quality of the communication link, the type of modulation and, also, the presence of noise in the system. Noise, as is well known, can come from many sources. One type of noise can actually come from other transmission systems. In the embodiment of FIG. 1, there is illustrated an interfering transmitter 120 which is operable to transmit a signal 122 into the transmission space of the receiver 104. Thus, the receiver 104 can receive the transmission signal 122 on its antennae 110. Typically, the receivers 104 have some type of band-pass or receive filter that will reject signals that are “out-of-band.” If the filter is narrow enough, only signals from the transmitter 102 will be received. However, depending upon the modulation, the filtering must recover energy from frequencies outside of the narrow band disposed about the carrier and bounded by the filter. Thus, depending upon the modulation technique, it is possible for some energy from the signal 122 from the transmitter 120 to affect the signal quality at the receiver 104 over the channel 108. This is referred to as “adjacent channel interference.” As will be described hereinbelow, the receiver 104 incorporates a filtering technique that will reject adjacent channel interference and recover less than all of the energy in the received signal without substantially affecting the quality of the received signal.

Referring now to FIG. 2, there is illustrated a diagrammatic view of the transmitter 102 and receiver 104. In the disclosed embodiment, the type of modulation utilized is offset-quadrature phase shift key (O-QPSK) modulation. This typically requires I- and Q-channels offset in phase by 90° whereas each of the channels operates with half-sine signals representing the digital values and referred to as “symbols.” This will be described in more detail hereinbelow. The transmitter 102 receives binary data into an I- and Q-signal generator 202 to generate the I- and Q-signals. The I-signal is input to an up converter 204 that is driven by an oscillator 206 to basically modulate the I-signal onto a carrier that is provided by the oscillator 206. The Q-signal is input to an up converter 208 which receives a 90° shifted signal from the oscillator 206 provided by a quadrature phase shift block 210. The output of the up converter 204 and the up converter 208 are summed together in a summing block 212 to provide an output on the communication channel 108.

The receiver 104 receives the signal on an input node 220. The receive signal is input to a down converter 222 which receives a clock signal from a clock recovery block 224, which clock recovery block 224 recovers the clock from the receive signal on node 220. This provides the I-signal at an intermediate frequency which is then filtered with a low pass filter 226 and then input to a digital logic block 228. Similarly, the Q-channel is derived through the use of a down converter 230 which receives the input signal from node 220 and a clock signal from the clock recovery block 224 shifted in phase by 90° by a quadrature phase shift block 234. This provides the Q-signal to a low pass filter 236, the output of which is input to the digital logic block 228. This provides a recovered data output therefrom. The digital logic block 228 provides the data processing operation wherein filtering is facilitated and data sampling is facilitated, as will be described in more detail hereinbelow. This where the large portion of the demodulation occurs at the baseband.

Referring now to FIG. 3, there is illustrated a more detailed diagram of the receiver 104. The output of the down converter 232 is input to an anti-aliasing filter 302 and, similarly, the output of the down converter 230 is input to the input of an anti-aliasing filter 304. These operate in the analog domain. The output of the anti-aliasing filter provides analog IF which is input to an analog-to-digital converter 306 to provide a digital IF output on a digital bus 308. The anti-aliasing filter 304 provides an analog IF for input to an analog-to-digital converter 310 to provide a digital IF output on a bus 312. The bus 308 is input to an I-channel demodulator 314 and the digital bus 312 is input to a Q-channel demodulator 316. The demodulators 314 and 316 each have the band-pass filter disclosed herein for providing the adjacent channel rejection while accounting for ISI interference such that the signal on the I-channel and the signal on the Q-channel can be recovered.

Referring now to FIG. 4, there is illustrated the half-sine symbol for the O-QPSK signal for a single bit. It can be seen that a bit period of 1.0 microsecond is illustrated with a half-sine signal occupying a T_{c} of 0.5 microsecond. In time, the O-QPSK symbol equation is:

$$\begin{matrix}s ( t ) = sin ( \frac{π}{2} \cdot \frac{t}{Tc} ) \\ where \text{:} & ( 1 ) \\ Tc = 0.5 μs & ( 2 )\end{matrix}$$

Thus, the half-sine signal will be a zero value at 0.0 μs, a maximum at 0.5 μs and a minimum at 1.0 μs.

Referring now to FIG. 5, there is illustrated a plot of the power spectral density for the half-sine symbol of FIG. 4. This is illustrated by a solid line 502 that has a main lobe from 0.0 to 1.5 MHz, a secondary lobe 504 from 1.5 to 2.5 MHz and decreasing lobes each 1 MHz thereafter. In general, in order to reconstitute this signal, a filtering scheme should be utilized to recover substantially all of the energy in all of the lobes. The O-QPSK power spectral density is defined as follows:

$$\vert S ( f ) \vert = \frac{1}{π} \cdot \frac{\frac{1}{4 \cdot Tc}}{{( \frac{1}{4 \cdot TC} )}^{2} - {f}^{2}} \cdot cos ( 2 π \cdot f \cdot TC ) \qquad ( 3 )$$

Conventional demodulators will filter the signal 502 at some frequency between 1.5 to 2.5 MHz in order to recover substantially all of the transmitted power. Typically, some type of matched filter will be utilized. However, it can be seen that a carrier centered about a frequency 510 at 1.0 MHz from the center frequency of the transmitted symbol will be well within the main lobe, thus having the potential to contribute noise due to adjacent channel interference. This is a conventional adjacent channel of the type referred to a Blue Tooth. This utilizes Gaussian Frequency Shift Keying (GFSK) which basically involves passing the input signal through a Gaussian filter and then through a simple FSK subsystem. This will result in the following relationship:

$$\begin{matrix}g ( t ) = \frac{1}{\sqrt{2 π} σ T} exp ( \frac{- {t}^{2}}{2 {σ}^{2} {T}^{2}} ) & ( 4 ) \\ σ = \frac{\sqrt{ln ( 2 )}}{2 π BT} & ( 5 )\end{matrix}$$

If this signal is present centered 1.0 MHz from the signal of interest, it can result in a sufficient amount of energy being within the filter band if the filter band is between 1.5 to 2.5 MHz. In the present disclosed embodiment, his center frequency 510 has modulation associated therewith that will occupy a bandwidth from 0.5 MHz to 1.5 MHz. Thus, it would be desirable to filter the signals such that all of the energy from 0.0 to 0.5 MHz is recovered, which is substantially 80% of the energy, while rejecting energy above 0.5 MHz, such that substantially all the energy that would be associated with the adjacent channel would be rejected. However, as will be described hereinbelow, a consideration for this filtering is the ISI that might result within the recovered signal. This is a function of the filtering. In general, to reduce ISI, an ideal pulse shape would have zeros in the impulse response that would go through zero at equally spaced intervals that are multiples of the sampling interval.

One type of filtering that can be utilized is that illustrated in FIG. 6 and satisfies the criteria to provide zero crossings at substantially intervals of the sampling interval. In FIG. 6, the unfiltered power spectral density (PSD) response 502 is subjected to a raised-cosine filter, this is illustrated with a filter shape 602. In general, this has a fairly flat in-band response with a slight roll-off at the corner frequency and then a very sharp roll-off to provide a pseudo brick-wall filter response at 0.5 MHz. A raised cosine filter is defined as a filter with a specific characteristic that no intersymbol interference at the sample times of adjacent signaling intervals. The raised cosine response will be as follows:

$$\begin{matrix}H ( f ) = 1 , f < {f}_{o} & ( 6 ) \\ H ( f ) = \cdot \frac{1 + cos ( \frac{π}{2 α} \cdot ( \frac{f}{{f}_{o}} - 1 + α ) )}{2} , f ∈ [ {f}_{o} \cdot ( 1 - α ) ; {f}_{o} \cdot ( 1 + α ) ] & ( 7 ) \\ H ( f ) = 0 , f > {f}_{o} \cdot ( 1 + α ) & ( 8 )\end{matrix}$$

The resultant channel response in the frequency domain is illustrated in FIG. 6a. In FIG. 6a, it can be seen that the flat pass-band response for the filter will basically have a shape from 0.0 to 0.5 MHz that basically tracks the PSD response 502 from the original PSD response. Thus, the PSD of the channel response after filtering will not be flat in band. To further refine this, the embodiment of FIG. 7 is referred to. In FIG. 7, the PSD response 502 is subjected to a filter that is a combination of a raised-cosine filter with an in band amplitude adjustment where it can be seen that the in band portion of the filter below 0.5 MHz has a gain associated therewith such that it will increase the response at 0.5 MHz and then roll off sharply at 0.5 MHz. The in-channel PSD response is illustrated in FIG. 7a, where it can be seen that the in band response is relatively flat.

For the filter response of FIG. 7 with the dotted line, the brick wall-like spectrum will be defined as follows. As a first approximation, the filter's frequency response is:

$$\begin{matrix}H ( f ) = \frac{1}{S ( f )} , f < {f}_{o} & ( 9 ) \\ H ( f ) = 0 , f > {f}_{o} & ( 10 )\end{matrix}$$

This is basically the inverse of the PSD for the half-sine symbol. This will account for the roll off of the PSD energy over the low frequency flat portion of the raised cosine filter response.

For practical implementation of the filter, to provide a channel response illustrated in FIG. 7a, the proposed transfer function, H(f), of Equations 9 and 10 can be combined with a raised cosine response:

$$\begin{matrix}H ( f ) = \frac{1}{S ( f )} , f < {f}_{o} \cdot ( 1 - α ) & ( 11 ) \\ H ( f ) = \frac{1}{S ( f )} \cdot \frac{1 + cos ( \frac{π}{2 α} \cdot ( \frac{f}{{f}_{o}} - 1 + α ) )}{2} , f ∈ [ {f}_{o} \cdot ( 1 - α ) ; {f}_{o} \cdot ( 1 + α ) ] & ( 12 ) \\ H ( f ) = 0 , f > {f}_{o} \cdot ( 1 + α ) & ( 13 )\end{matrix}$$

The resulting channel response in FIG. 7a will therefore be that of a raised cosine response:

$$\begin{matrix}H ( f ) = 1 , f < {f}_{o} \cdot ( 1 - α ) & ( 14 ) \\ H ( f ) = \frac{1 + cos ( \frac{π}{2 α} \cdot ( \frac{f}{{f}_{o}} - 1 + α ) )}{2} , f ∈ [ {f}_{o} \cdot ( 1 - α ) ; {f}_{o} \cdot ( 1 + α ) ] & ( 15 ) \\ H ( f ) = 0 , f > {f}_{o} \cdot ( 1 + α ) & ( 16 )\end{matrix}$$

The results for a value of α=0.2 are illustrated in FIG. 8, wherein the unfiltered O-QPSK channel is illustrated with a PSD response 802, the proposed base band filter response is illustrated with a filter response 804 and the filter O-QPSK channel is illustrated with a filter response 806.

The Fourier transformer of the filtered response will result in the channel time response therefor. For a single half symbol, FIG. 9 illustrates the channel response for two cases, one for processing the signal through a standard raised cosine filter, which results in a response 902 and the other for processing through the filter response of FIG. 7. For the response 904, it can be observed that the zeros for the timed response occur at exact intervals of 2 T_{c}, allowing for minimum ISI with the response of FIG. 7, whereas the standard raised cosine filter results in only approximate zero-crossings. For example, at 1.0 μs, the response 904 will have a zero at a point 906. However, the “null” of the response 902 will occur at a point 908 that is not quite at 1.0 μs. Each of the nulls in the response 902 will be slightly off from the exact 2.0 T_{c}. Thus, as will be described hereinbelow with respect to the discussion of FIG. 10, each symbol is sampled at one microsecond time increments and, therefore, the response 904 will insure that the amount of signal contributed to a subsequent sample is substantially zero at the sampling time thereof. For example, the signal sample occurring at 1.0 μs after the signal illustrated in FIG. 9 will have a substantially zero contribution from the response 904 at the point of sampling, but the response 902 will provide a contribution at a point 912 that is approximately 23 dB down. The point 906 will be approximately 100 dB down, a considerable difference. Thus, the ISI between two adjacent symbols at 1.0 μs out will be approximately −23 dB. It can therefore be seen that by utilizing the inverse of S(f) in combination with the raised cosine filter function at the corner frequency, the attenuation in the time domain at the sampling points of each symbol is increased over the raised cosine filter function in and of itself.

Referring now to FIG. 10, there is illustrated a channel time response for subsequent symbols. The signal, when modulated, is illustrated as a plurality of half-sine symbols. For a data sequence “110010” there will be two positive half-sine symbols, two negative half-sine symbols, a positive half-sine symbols and then a negative half-sine symbols. The first half-sine symbols, half-sine symbols 1002, will have associated therewith a first channel time response that will occur at time t₀. This will be substantially the sampling time thereof, such that the recovered data will be sampled at time t₀. As described hereinabove, a time response for the half-sine symbol 1002 will result in a zero at 1.0 μs from t₀, a zero at 2.0 μs, etc. A second symbol, 1006, will be generated which will have a channel time response defined by a second waveform at t₁. The time t₁ will occur at 1.0 μs, which, if the data stream is sampled at t₁, this will result in the sampling occurring at 1.0 μs from t₀ such that the contribution from the time response of symbol 1002 will be zero. This will continue wherein a third symbol 1008 will have a sampling point at t₂, which will occur at a zero for the second symbol 1006 and a zero for the first symbol 1002. This will continue for the fourth symbol, symbol 1010, having a sampling point at t₃ which, again, occurs at a zero associated with the channel time responses of symbols 1002, 1006 and 1008. A fifth channel time response is illustrated for the next and fifth symbol, 1012, which will be sampled at time t₄, which, again, will occur at the zeros for the channel time responses for symbols 1002, 1006, 1008 and 1010. The actual signal output would be the sum of all of the channel time responses for all of the symbols, wherein it can be seen that by sampling at the periods t₀, t₁, t₂, t₃, t₄, etc., each sample will occur at the zero for adjacent and previous symbols such that ISI is substantially eliminated.

The filter function is realized with a digital filter. This can either be a finite impulse response filter or an infinite impulse response filter. The finite impulse response filter (FIR) is one that is utilized in the present disclosure. FIR filters have typically been referred to as moving average filters, transversal filters and non-recursive filters. These are conventional filters. The time response for one FIR implementation is depicted in FIG. 11 for an alpha value of 0.4.

Referring now to FIG. 12, there is illustrated a more detailed diagram of the receiver and the digital portion thereof. The analog IF channel is input to an ADC 1202 which is then processed through a digital down converter 1204. The output of the digital down converter provides a digital IF on a bus 1206 which is then processed through a digital channel filter 1208 that provides the band-pass function, this being a FIR filter. This will typically have associated therewith filter coefficients in a storage area 1210, these defining the operation of the filter. Once filtered, the output is then subjected to digital sub-sampling and clock recovery in a block 1212. Additionally, the digital down converter 1204 utilizes some of the clock recovery for a complex digital multiplication, this being well known. The output will provide a recovered clock and data to a digital comparator 1214 to provide the recovered data. This is for a single channel which can then be combined with the data from the output channel.

Although the preferred embodiment has been described in detail, it should be understood that various changes, substitutions and alterations can be made therein without departing from the spirit and scope of the invention as defined by the appended claims.

What is claimed is:

1. A method for filtering a received RF signal modulated with a time series sampled data signal, each data sample occurring within a bit time, comprising the steps of:
filtering at least a portion of the signal such that in the frequency domain a portion of the spectral energy therein above a corner frequency is rejected by applying a bandpass filter having a first filter transfer function thereto and the portion of the spectral energy therein below the corner frequency is filtered with a second filter transfer function to allow a substantial portion of the spectral energy below the corner frequency to pass there through; and
in the time domain, each of the first and second filter functions each disposing substantial attenuation regions forward in time with the step of filtering such that the attenuation regions are disposed within the bit time of subsequent data samples of the time series sampled data signal in the time domain;
wherein sampling of a given filtered received time series sampled data signal occurs substantially proximate in time to the substantial attenuation associated with prior data samples.

2. The method of claim 1, wherein the step of filtering with the first filter function is operable to reject a band of frequencies occupied by an unwanted transmission.

3. The method of claim 2, wherein the spectrum of the received RF signal is a sine x/x response with a power spectral density having a primary lobe and secondary lobes and a substantial portion of the spectral energy of the unwanted transmission is within the primary lobe of the power spectral density of the received RF signal.

4. The method of claim 3, wherein the time series sampled data signal is encoded with an M-ary Phase Shift Key (PSK) modulation comprised of a plurality of half sine symbols.

5. The method of claim 4, wherein the M-ary PSK modulation is Offset Quadrature PSK (O-QPSK) modulation.

6. The method of claim 5, wherein the step of disposing substantial attenuation forward in time is operable to reduce inter symbol interference (ISI) since energy from prior symbols is substantially attenuated at the time of sampling of the filtered signal.

7. The method of claim 4, wherein the step of filtering comprises passing the received signal through a raised cosine filter wherein the time domain response thereof has regions of attenuation disposed proximate to time of sampling of subsequent symbols.

8. The method of claim 7, wherein the time between symbols is Tc and the regions of attenuation are disposed from the sampling point of a given received symbol during the step of filtering by integral multiples of Tc.

9. The method of claim 7, wherein the sampling point is at substantially the center of the received filtered symbol.

10. The method of claim 5, wherein the O-QPSK signal has I- and Q-quadrature components and the at a least a portion comprises either the I- or Q-quadrature component.

11. The method of claim 5, wherein the first filter function comprises a raised cosine filter.

12. The method of claim 11, wherein O-QPSK signal has a transfer function of S(f) and the second filter function has a transfer function of 1/S(f) and the combined first filter function and the raised cosine filter has a transfer function of:
$$H ( f ) = \frac{1}{S ( f )} , f < {f}_{o} \cdot ( 1 - α )$$
$$H ( f ) = \frac{1}{S ( f )} \frac{1 + cos ( \frac{π}{2 α} \cdot ( \frac{f}{{f}_{o}} - 1 + α ) )}{2} , f ∈ [ {f}_{o} \cdot ( 1 - α ) ; {f}_{o} \cdot ( 1 + α ) ]$$
$$H ( f ) = 0 , f > {f}_{o} \cdot ( 1 + α )$$

13. A filter for filtering a received RF signal modulated with a time series sampled data signal, each data sample occurring within a bit time, comprising:
a bandpass filter having a first filter transfer function for filtering at least a portion of the signal such that in the frequency domain a portion of the spectral energy therein above a corner frequency is rejected;
a second filter having a second filter transfer function for filtering the portion of the spectral energy therein below the corner frequency is filtered to allow a substantial portion of the spectral energy below the corner frequency to pass there through; and
in the time domain, each of the first and second filter functions each disposing substantial attenuation regions forward in time with the step of filtering such that the attenuation regions are disposed within the bit time of subsequent data samples of the time series sampled data signal in the time domain;
wherein sampling of a given filtered received time series sampled data signal occurs substantially proximate in time to the substantial attenuation associated with prior data samples.

14. The filter of claim 13, wherein the first filter function is operable to reject a band of frequencies occupied by an unwanted transmission.

15. The filter of claim 14, wherein the spectrum of the received RF signal is a sine x/x response with a power spectral density having a primary lobe and secondary lobes and a substantial portion of the spectral energy of the unwanted transmission is within the primary lobe of the power spectral density of the received RF signal.

16. The filter of claim 14, wherein the time series sampled data signal is encoded with an M-ary Phase Shift Key (PSK) modulation comprised of a plurality of half sine symbols.

17. The filter of claim 14, wherein the M-ary PSK modulation is Offset Quadrature PSK (O-QPSK) modulation.

18. The filter of claim 16, wherein the substantial attenuation regions disposed forward in time are operable to reduce inter symbol interference (ISI) since energy from prior symbols is substantially attenuated at the time of sampling of the filtered signal.

19. The filter of claim 15, wherein the first filter function comprises a raised cosine filter wherein the time domain response thereof has regions of attenuation disposed proximate to time of sampling of subsequent symbols.

20. The filter of claim 19, wherein the time between symbols is Tc and the regions of attenuation are disposed from the sampling point of a given received symbol during the step of filtering by integral multiples of Tc.

21. The filter of claim 19, wherein the sampling point is at substantially the center of the received filtered symbol.

22. The filter of claim 17, wherein the O-QPSK signal has I- and Q-quadrature components and the at a least a portion comprises either the I- or Q-quadrature component.

23. The filter of claim 17, wherein the first filter function comprises a raised cosine filter.

24. The filter of claim 23, wherein the O-QPSK signal has a transfer function of S(f) and the second filter function has a transfer function of 1/S(f) and the combined first filter function and the raised cosine filter has a transfer function of:
$$H ( f ) = \frac{1}{S ( f )} , f < {f}_{o} \cdot ( 1 - α )$$
$$H ( f ) = \frac{1}{S ( f )} \frac{1 + cos ( \frac{π}{2 α} \cdot ( \frac{f}{{f}_{o}} - 1 + α ) )}{2} , f ∈ [ {f}_{o} \cdot ( 1 - α ) ; {f}_{o} \cdot ( 1 + α ) ]$$
$$H ( f ) = 0 , f > {f}_{o} \cdot ( 1 + α )$$
